(19) United States
(12) Patent Application Publication
(10) Pub. No.: US 2010/0070518 A1
(43) Pub. Date: Mar. 18, 2010

(54) METHOD FOR PROTECTING PRIVATE INFORMATION AND COMPUTER-READABLE RECORDING MEDIUM STORING PROGRAM FOR EXECUTING THE SAME

(76) Inventors: Joong Hwan PARK, Seoul (KR); Dong Jin BAEK, Seoul (KR); Il Hoon CHOI, Seoul (KR); Gi Hyouk LEE, Seoul (KR); Dae Hwan KIM, Seoul (KR)

Correspondence Address: North Star Intellectual Property Law, PC, P.O. Box 34688, Washington DC, DC, 20043, US

(21) Appl. No.: 12/417,490

(22) Filed: Apr. 2, 2009

(30) Foreign Application Priority Data
Sep. 12, 2008 (KR) 10-2008-0090247

(51) Int. Cl. G06F 17/30; G06F 21/00

(52) U.S. Cl. 707/758; 726/26; 707/E17.014

(57) ABSTRACT

Provided are a method for protecting private information and a computer-readable recording medium storing program for the same. The method may include defining a pattern corresponding to the private information, automatically searching whether the private information is included in the file and the mail stored in a personal computer, according to predetermined intervals on the basis of the pattern, and performing an information protecting operation when the file or the mail including the private information is searched.

### CROSS-REFERENCE TO RELATED APPLICATION(S)

This application claims the benefit under 35 U.S.C. §119(a) of a Korean Patent Application No. 10-2008-0090247, filed on Sep. 12, 2008, the disclosure of which is incorporated herein by reference in its entirety.

### TECHNICAL FIELD

The following disclosure relates to a method for protecting private information, and in particular, to a method for protecting private information and a computer-readable recording medium storing program for executing the same, which may prevent private information in, for example, a personal computer (PC) from being leaked.

### BACKGROUND

Generally, the development of a computer is leading to the computerization of works at home or company. Accordingly, data generated by the computerization are stored in a PC, or are stored in a separate portable storage medium so that they are moved or managed. The examples of the existing storage medium include internal hard disk (which is mounted in a PC), CDROM, floppy disk, external hard disk (which is external to a PC), Zip drive, Multimedia Memory Card (MMC). Such a storage medium expands a computing environment capable of storing and sharing data.

The related art stores data in a type of plaintext upon the generation and management of the data. Since security for this must be additionally achieved by separate software, stability must be considered in exchanging data between a plurality of users, and there also arise limitations for compatibility in exchanging data between various computing systems. Moreover, data can be leaked to other user upon storage of the data for movement.

Particularly, in a case where a user accesses a file or a mail including private information for the purpose of work and continuously keeps it without deleting it even after the end of the work, the related art has a possibility of danger that the file or the mail can be leaked to other users.

Accordingly, private information such as a resident registration number stored in a computing device such as a PC may be encrypted. However, since the existing search engine and search method may search a keyword but do not have a search function using a pattern, it may not be possible to perform a search type such as finding data including a resident registration number. As such, the related art may still have the above-described possibility of danger to leak private information.

### SUMMARY

Accordingly, according to one general aspect, there is provided a method for protecting private information and a computer readable recording medium storing program for executing the same, which searches data including private information, and protects the private information by encrypting or deleting the data, so as to prevent the private information from being leaked to another user.

According to another aspect, there is provided a method for protecting private information and a computer readable recording medium storing program for executing the same, which uses a management folder storing only encrypted data including private information, and enables to access the management folder only by separate authentication, so as to improve efficiency for security.

According to another aspect, there is provided a method for protecting private information included in a file and a mail stored in a personal computer (PC), the method including: defining a pattern corresponding to the private information; automatically searching whether the private information is included in the file and the mail stored in the PC, according to predetermined intervals on the basis of the pattern; and performing an information protecting operation when the file or the mail including the private information is searched.

According to another aspect, there is provided a computer-readable recording medium storing a program for executing a method for protecting private information included in a file and a mail stored in a personal computer (PC), the computer-readable recording medium executing: defining a pattern corresponding to the private information; automatically searching whether the private information is included in the file and the mail stored in the PC, according to predetermined intervals on the basis of the pattern; and performing at least one of storing a list, warning to a user, deleting a file, encrypting and moving to a designated folder, when the file or the mail including the private information is searched.

Other features and aspects will be apparent from the following detailed description, the drawings, and the claims.

### BRIEF DESCRIPTION OF THE DRAWINGS

FIG. 1 is a flowchart illustrating an exemplary method for protecting private information in a PC by an encryption assignment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF EMBODIMENTS

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Embodiments described herein may be performed by a program readable with a computer or a digital device such as it, or by a recording medium where the program is recorded. That is, the computer or the digital device such as it may run a program to execute a method for protecting private information in, for example, a PC. In the operation description of the method according to an exemplary embodiment, it may be assumed that the subject of operation is the controller of an operation device.

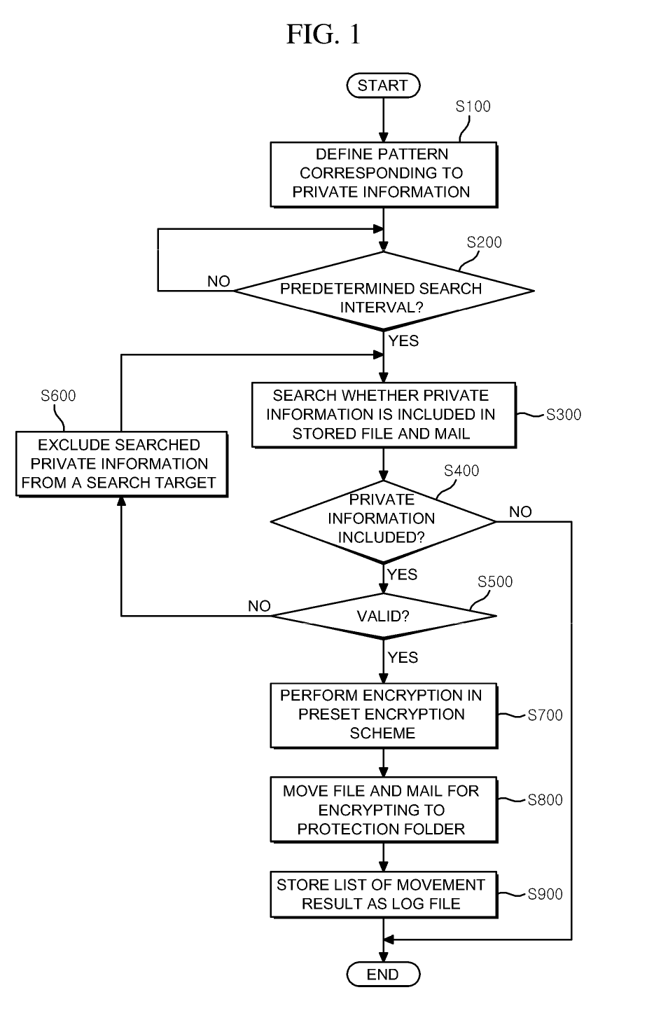

FIG. 1 is a flowchart illustrating an exemplary method for protecting private information in, for example, a PC by an encryption assignment.

Referring to FIG. 1, a pattern corresponding to private information is first defined to protect the private information stored in a PC in operation S100. At this point, the defined pattern may include information for the identification of the private information such as a resident registration number, a driver's license number, a passport number, an account number, a telephone number, a mobile phone number, a card number, an Internet Protocol (IP) number, a residential address and an email number, and may be defined as regular expression and keyword complex matching. For example, if a resident registration number is represented as the regular expression, it may be represented as “[0-9]{6}(-|[ ])?(1|2|3|4)[0-9]{6}”. Herein, “[0-9]{6}” means that numerals from 0 to 9 are repeated six times, “(-|[ ])?” means that a hyphen (-) or a blank is matched zero times or one time (the hyphen or the blank exists or not), and “(1|2|3|4)” means that a numeral corresponding to 1, 2, 3 or 4 appears.

Moreover, the keyword complex matching may denote that a keyword is complexly described as the logical operators of “AND”, “OR” and “NOT”. As an example, it is assumed that “&”, “|” and “!” is an AND operator, an OR operator and a NOT operator, respectively. On this assumption, if the keyword complex matching is performed with “(‘tangjeong’&‘512DDR’)$(!(‘pilot’)|‘yield’)”, this denotes a document where a keyword “tangjeong” and a keyword “512DDR” are included and a word “pilot” is not included or a keyword “yield” is included.

A user gives a definition of the pattern by itself, or a company gives a definition of the pattern according to security guidelines for the entirety of its organization. In a case of pre-approval, the pattern may be changed on-line. Moreover, depending on the case, the pattern may be defined as any pattern designated for search, in addition to the private information.

The controller automatically searches the kinds of the file and the mail according to predetermined intervals (for example, one-day intervals, one-week intervals, and one-month intervals) for checking whether the private information is included in the file and the mail stored in the PC in operation S300, and checks whether the private information is included in the file and the mail stored in the PC in operation S400. At this point, the controller may check whether the private information is included in a file encrypted with Digital Rights Management (DRM) in linkage with a decryption library upon search. Since the DRM enables only an authorized user having an encryption key to decrypt and use the encrypted file, users must receive the encryption key by authentication in advance.

Moreover, when there exists a file attached to the stored mail upon search, the controller may also extract the keyword of the attached file and analyzes whether the private information exists or not. When the attached file has a type of a compressed file, the controller may decompress and analyze the attached file. At this point, when there is a mail (for example, a mail which is stored in a trash, a deleted mailbox and the like) that is temporarily deleted in the PC, the controller may recover and analyze the contents of the deleted mail (the title and text of the deleted mail). In a case where the extension of the attached file is changed (for example, a case where only the extension is changed into the extension of a Hangeul file (the Hangeul is the Korean alphabet) without changing the format of a Word file), the controller may discriminate the changed extension, recover it into the file format of the original extension, extract the keyword of the recovered file, and analyze the recovered file. In a case where the file is encrypted with a password, the controller may make a separate list, so as to enable a succeeding user to manually analyze the file.

Moreover, a searched file and a searched mail may be researched only when their contents are changed, so as to increase the speed of a search.

Subsequently, when a file or a mail including the private information is searched, the controller checks the validity of the searched private information in operation S500. For example, when the searched private information is a resident registration number (900101-______), the controller may inquire the searched resident registration number into the Ministry of Public Administration and Security (which is one of the governments of Korea) and check whether the searched resident registration number is valid. When the searched resident registration number is invalid, the controller may exclude the searched private information from a search target in operation S600.

When the file or the mail including the private information is searched, the controller may perform an operation for protecting information. In this case, the controller performs the operation in a protection scheme that is predetermined by a user.

That is, in a case where the protection scheme is an encryption scheme that is preset by the user, a corresponding file or a corresponding mail is encrypted in operation S700. In this step, the file or the mail may be automatically or manually encrypted according to the preset encryption scheme.

In a case where the preset encryption scheme is an auto encryption scheme, the controller may perform the encryption in one or more encryption schemes such as a public key-based asymmetric encryption algorithm (RSA) or a private key-based symmetric encryption algorithm (KSE96). In a case where the preset encryption scheme is a manual encryption scheme, when a hard-copied encryption key is manually input, the controller may perform the encryption in a preset encryption scheme.

Upon encryption, the controller may perform the encryption of a designated file, and also perform the encryption of a disk unit and the encryption of a file unit in parallel, so as to further improve security.

Moreover, the controller may watch files which are created, moved, deleted or copied from a designated disk drive or a specific folder (for example, a folder keeping a special management data) at discretion and keep the files as a log. A file created or copied from the specific folder may be compulsorily encrypted.

After the encryption, the controller may moves the encrypted file and mail to one or more protection folders in operation S800, and store the list of the movement result as a log file when moving to the protection folder in operation S900.

Accordingly, upon deletion or access of the log file stored in the protection folder, the controller may give an authorization for deletion or access only by separate authentication.

Moreover, when the encrypted file stored in the protection folder is moved to a portable media (for example, USB and the like) or is output as a printed material, the controller may authorize the movement or the output only when approved in advance.

In a case where the user has designated the catalog storage of the file or the mail including the searched private information, the controller may separately store the searched catalog list.

In a case where the user has designated a file deletion, as soon as the file or the mail including the private information is searched, the controller may completely delete the searched file or mail not to recover it, so as to further improve security for information.

In a case where the user has designated movement to a designated folder, the controller may automatically move the file and the mail including the searched private information to the designated folder.

In a case where the user has designated a user warning, the controller may output a warning message to the user when the file and the mail including the private information is searched and is kept for more than a predetermined term. That is, when the file and the mail including the private information stored in the designated folder and the protection folder is kept for more than a predetermined keeping term, the controller may output the warning message.

For example, assuming that the predetermined keeping term is thirty days, when there exists a file including the private information which is being kept for a long time even after the elapse of thirty days being the predetermined term, the controller may output both a message representing that there is the file kept for a long time and a message advising a backup to the user. When the user has never accessed a corresponding file for the predetermined keeping term, the controller may output a message advising a deletion. At this point, the controller may output the warning message at regular intervals until the backup and the deletion are performed.

A security grade may be applied according to the kind of a pattern and the number of repeated times defined in a file or a mail that is found upon protection of information, and an information protecting process may be differently set according to the security grade.

For example, it is assumed that a document is set at a low security grade when it includes ten or less resident registration numbers and a document is set at a high security grade when it includes thousand or more resident registration numbers, or a document is set at a low security grade when it includes only one pattern and a document is set at a high security grade when a document simultaneously includes three or more patterns. In these cases, when a file having a high security grade is found, it may be encrypted. When a file having a low security grade is found, it may be deleted or moved to a designated folder.

In an exemplary embodiment described above, the encryption process, the file deleting process and the user warning process have been separately described, but at least two processes of the processes may be performed in linkage with each other depending on the case.

That is, the encryption process and the user warning process may be performed in linkage with each other, the process of moving to the designated folder and the user warning process may be performed in linkage with each other, and all the processes may be performed in linkage with one another.

A method for protecting private information and a computer readable recording medium for the same according to an exemplary embodiment, compulsorily encrypts and stores data including private information, so as to prevent the private information from being leaked to another user.

A method for protecting private information and a computer readable recording medium for the same according to an exemplary embodiment, completely deletes an encrypted file not to recover it upon deletion of the encrypted file, and enables to access a management folder only by separate authentication by using the management folder storing only encrypted data including private information, so as to improve efficiency for security.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for protecting private information included in a file and a mail stored in a personal computer (PC), the method comprising:
defining a pattern corresponding to the private information;
automatically searching whether the private information is comprised in the file and the mail stored in the PC, according to predetermined intervals on the basis of the pattern; and
performing an information protecting operation when the file or the mail comprising the private information is searched.

2. The method of claim 1, wherein the defined pattern is personally identifiable information comprising at least one of a resident registration number, a driver's license number, a passport number, an account number, a telephone number, a mobile phone number, a card number, an Internet Protocol (IP) number, a residential address and an email number.

3. The method of claim 2, wherein the pattern is defined as regular expression and keyword complex matching.

4. The method of claim 1, wherein the searching of the private information comprises checking a validity of a searched file or mail when the file or the mail comprising the private information is searched.

5. The method of claim 1, wherein the searching of the private information comprises checking whether private information is comprised in a searched file in linkage with a decryption library, when the file encrypted with Digital Rights Management (DRM) is searched.

6. The method of claim 1, wherein the searching of the private information comprises making a separate list to provide the list to a user, when a file is encrypted with a password.

7. The method of claim 1, wherein the searching of the private information comprises recovering and analyzing contents of a deleted mail upon search.

8. The method of claim 7, wherein the searching of the private information further comprises:
extracting and analyzing a keyword of an attached file when there exists the file attached to a stored mail upon search;
decompressing and analyzing the attached file when the attached file has a type of a compressed file; and
recovering an extension of the attached file into an extension of a previous attached file and analyzing the attached file, when the extension of the attached file is changed.

9. The method of claim 1, wherein the searching of the private information comprises preventing a research when contents of a searched file and mail are not changed.

10. The method of claim 1, wherein the performing of the information protecting operation comprises automatically or manually encrypting the file or the mail according to a preset encryption scheme, upon encryption according to a search of the file or the mail comprising the private information.

11. The method of claim 10, wherein the auto encryption scheme is one of a public key-based asymmetric encryption algorithm (RSA) or a private key-based symmetric encryption algorithm (KSE96).

12. The method of claim 10, wherein an encryption of a disk unit and an encryption of a file unit are performed in parallel upon encryption.

13. The method of claim 1, wherein the performing of the information protecting operation comprises completely deleting the file or the mail not to be recovered when a deletion of the file or the mail comprising the private information is required.

14. The method of claim 1, wherein the performing of the information protecting operation comprises:
moving the encrypted file and mail to one or more designated folders, and storing a list of the movement result as a log file; and
giving an authorization for deletion or access by separate authentication, upon deletion or access of the log file.

15. The method of claim 1, wherein the performing of the information protecting operation comprises authorizing storage or output according to whether an approval is given in advance, when the encrypted file or the file comprising the private information is stored in a portable media or is output as a printed material.

16. The method of claim 1, wherein the performing of the information protecting operation comprises outputting a warning message to a user when the file and the mail comprising the private information is searched and is kept for more than a predetermined term.

17. A computer-readable recording medium storing a program for executing a method for protecting private information included in a file and a mail stored in a personal computer (PC), the computer-readable recording medium executing:
defining a pattern corresponding to the private information;
automatically searching whether the private information is comprised in the file and the mail stored in the PC, according to predetermined intervals on the basis of the pattern; and
performing at least one of storing a list, warning to a user, deleting a file, encrypting and moving to a designated folder, when the file or the mail comprising the private information is searched.
